(19) United States
(12) Patent Application Publication
(10) Pub. No.: US 2021/0269351 A1
(43) Pub. Date: Sep. 2, 2021

(54) HANDHELD SHEET EDGE STRIP SEPARATION DEVICES AND METHODS OF SEPARATING GLASS SHEETS

(71) Applicant: CORNING INCORPORATED, CORNING, NY (US)

(72) Inventor: Michael Aaron Zahradka, Painted Post, NY (US)

(21) Appl. No.: 17/259,347

(22) PCT Filed: Jun. 27, 2019
(86) PCT No.: PCT/US2019/039487

§ 371 Date: Jan. 11, 2021

Related U.S. Application Data
(60) Provisional application No. 62/698,548, filed on Jul. 16, 2018.

(51) Int. Cl. C03B 33/12; C03B 33/033

(52) U.S. Cl. CPC C03B 33/12; C03B 33/033

(57) ABSTRACT

A method of separating an edge strip of a sheet of brittle material using a handheld sheet edge strip separation device is provided. The method includes sliding an edge receiving channel of a separation body of the sheet edge strip separation device over an edge portion that includes an edge of the sheet of brittle material. The edge receiving channel has a fixed width and is integrally formed as part of the separation body. The sheet edge strip separation device is rotated to provide a force over an area of the edge portion. The edge strip is separated from a quality portion of the sheet of brittle material with the glass edge strip located in the edge receiving channel.

### CROSS-REFERENCE TO RELATED APPLICATION

This application claims the benefit of priority under 35 U.S.C. § 119 of U.S. Provisional Application Ser. No. 62/698,548 filed on Jul. 16, 2018, the content of which is relied upon and incorporated herein by reference in its entirety.

### TECHNICAL FIELD

The present invention relates to methods and devices for separating edge strips from sheets of brittle material and, in particular, handheld sheet edge strip separation devices and associated methods for separating glass sheet edge strips from quality portions of the glass sheets.

### BACKGROUND

Thin glass sheets have found use in many optical, electronic or optoeletronic devices, such as liquid crystal displays (LCD), organic light-emitting diode (OLED) displays, solar cells, as semiconductor device substrates, color filter substrates, cover sheets, and the like. The thin glass sheets, having a thickness from several micrometers to several millimeters, may be fabricated by a number of methods, such as float process, fusion down-draw process (a method pioneered by Corning Incorporated, Corning, N.Y., U.S.A.), slot down-draw process, and the like.

In many of the applications of thin glass sheets, it is highly desired that the glass sheets have pristine surface quality essentially free of scratches, particles, and other defects, high thickness uniformity and low surface roughness and waviness. To that end, in the forming process for making the glass sheets, typically direct contact of the center region of major surfaces of the as-formed glass sheet with solid surfaces is avoided. Instead, only the peripheral region of the glass sheet may be subjected to direct contact with solid surfaces such as edge rolls, pulling rolls, edge guiding rolls, and the like. Thus, the peripheral portions of both sides of an as-formed glass sheet obtained directly from the forming device, such as in the bottom-of-draw area of a fusion down-draw or slot down-draw process, sometimes called edge beads, tend to have lower surface quality than the center region of the major surfaces. In addition, depending on the specific forming device used, the peripheral portions tend to have different thickness and significantly higher thickness variation than the center quality region.

Various edge bead removal technologies are used with different yield, yield consistency, and cost of the processes and equipment. Often, the edge bead removal technologies are used in a controlled environment and utilized automated apparatuses. What are needed are handheld sheet edge strip separation devices and associated methods for separating glass sheet edge strips from quality portions of the glass sheets that can be used in downstream edge strip removal processes.

### SUMMARY

The present disclosure involves the separation of edge strips of a glass sheet using handheld sheet edge strip separation devices. The sheet edge strip separation devices are sized and shaped to be held in a hand of a user and include at least one edge receiving channel that is sized to slidingly receive an edge region of a glass sheet. The sheet edge strip separation devices may then be manually operated to remove an edge strip from a central quality portion of the glass sheets.

According to a first aspect, a method of separating an edge strip of a sheet of brittle material using a handheld sheet edge strip separation device, the method comprising: sliding an edge receiving channel of a separation body of the sheet edge strip separation device over an edge portion that includes an edge of the sheet of brittle material, the edge receiving channel having a fixed width and is integrally formed as part of the separation body; rotating the sheet edge strip separation device to provide a force over an area of the edge portion; and separating the edge strip from a quality portion of the sheet of brittle material with the edge strip located in the edge receiving channel.

According to a second aspect, a handheld sheet edge strip separation device, comprising: a separation body comprising an edge receiving channel that extends along a length of the separation body, the edge receiving channel having a fixed width and is integrally formed as part of the separation body; wherein the edge receiving channel is sized to receive an edge portion of a sheet of brittle material.

According to the third aspect, a method of forming a handheld sheet edge strip separation device, the method comprising: forming a separation body of the sheet edge strip separation device, the separation body having a first end, a second end and sides that extend from the first end to the second end; and providing the separation body with an edge receiving channel that extends inwardly from a face of the separation body, the glass edge receiving channel having a fixed width and is integrally formed as part of the separation body.

Additional features and advantages will be set forth in the detailed description which follows, and in part will be readily apparent to those skilled in the art from the description or recognized by practicing the invention as exemplified in the written description and the appended drawings and as defined in the appended claims. It is to be understood that both the foregoing general description and the following detailed description are merely exemplary of the invention, and are intended to provide an overview or framework to understanding the nature and character of the invention as it is claimed.

The accompanying drawings are included to provide a further understanding of principles of the invention, and are incorporated in and constitute a part of this specification. The drawings illustrate one or more embodiment(s), and together with the description serve to explain, by way of example, principles and operation of the invention. It is to be understood that various features of the invention disclosed in this specification and in the drawings can be used in any and all combinations.

### BRIEF DESCRIPTION OF THE DRAWINGS

FIG. 1 is a schematic side view of a perspective view of a handheld sheet edge strip separation device, according to one or more embodiments shown and described herein;

FIG. 2 is a perspective view of a sheet of brittle material in the form of a glass sheet, according to one or more embodiments shown and described herein;

FIG. 3 is a plan view of the sheet edge strip separation device of FIG. 1;

FIG. 4 is a side view of the sheet edge strip separation device of FIG. 1;

FIG. 5 is an end view of the sheet edge strip separation device of FIG. 1;

FIG. 6 illustrates a process of separating an edge strip from a sheet of brittle material using the edge strip separation device of FIG. 1, according to one or more embodiments shown and described herein;

FIG. 7 illustrates a method of separating an edge strip from a sheet of brittle material using the edge strip separation device of FIG. 1, according to one or more embodiments shown and described herein;

FIG. 8 is a schematic section view of a strengthened glass-ceramic, according to one or more embodiments shown and described herein;

FIG. 9 illustrates an exemplary stress profile for the first half of the thickness of the glass-ceramic of FIG. 8; and

FIG. 10 is a schematic section view of a strengthened glass-ceramic, according to one or more embodiments shown and described herein.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

Currently, glass edge strip separation of glass sheets is performed by hand requiring pressure to be applied as well as rotation of the wrist. This repetitive motion of the hand and skin-to-glass contact may result in injury to the hand and wrist. For mass production of glass sheets, edge strip separation may be performed using an automated process. For smaller scale and development processes using glass sheets, a smaller, handheld sheet edge strip separation device may be desired.

Embodiments described herein generally relate to handheld sheet edge strip separation devices and associated method of use, where the sheet edge strip separation devices may be used to manually separate edge strips from glass sheets. The sheet edge strip separation devices include a separation body and at least one edge receiving channel that is sized to slidingly receive an edge portion of a glass sheet. Rotation of the sheet edge strip separation device vents and then separates the edge portion along a line of weakness (e.g., a score line) along an entire length of the glass sheet in a single motion.

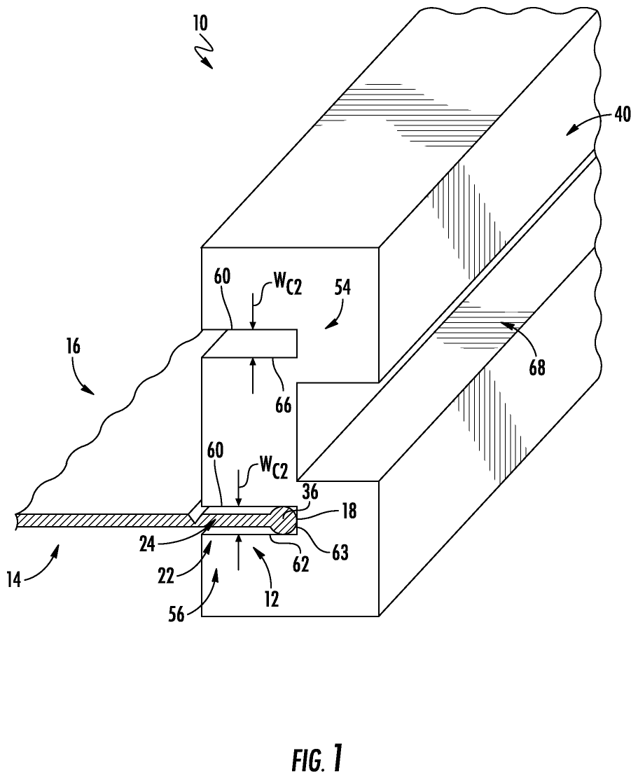

Referring to FIG. 1, a handheld sheet edge strip separation device 10 is illustrated in an edge strip separation process where an edge strip 12 is in the process of being separated from a central quality portion 14 of a glass sheet 16. As used herein, the term “edge strip” refers to a portion of the glass sheet 16 that includes an edge 18 to be or already removed. As will be described in greater detail below, the sheet edge strip separation device 10 has a separation body 40 having at least one edge receiving channel 22 that is sized to slidingly receive an edge portion 24 of the glass sheet 16.

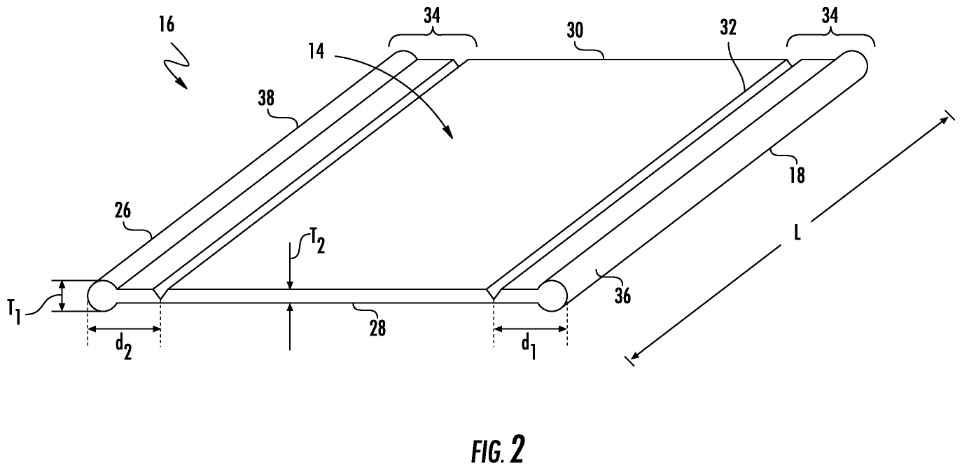

In some embodiments, such as the one shown, the edge portion 24 includes an edge bead 36. Referring briefly to FIG. 2, the glass sheet 16 has a first pair of opposite edges 18, 26 and second pair of opposite edges 28 and 30, forming a rectangular shape. While a rectangular shape is illustrated, other, non-rectangular shapes may be provided. The first edge portion 24 is provided that includes the edge 18 and extends in a widthwise direction a distance d₁ to a score line 32 that extends along a length L of the glass sheet 16. The score line 32 is a line of weakness that may be formed using any suitable method, such as by mechanical scoring, for example, using a carbide or diamond wheel or by energy, such as using a laser. A second edge portion 34 is provided that includes the edge 26 and extends in the widthwise direction a distance d₂ to another score line 36 that extends along the length L of the glass sheet 16. The distances d₁ and d₂ may be the same or they may be different.

In some embodiment, due to the down draw fusion process of forming the glass sheets, the edge portions 24 and 34 of the glass sheet 16 may have corresponding edge beads 36 and 38 with a thickness T₁ that is greater than a thickness T₂ of the quality portion 14 that is located between the edge portions 24 and 34. In some embodiments, the thickness T₂ may be about 0.7 mm or more, such as about 1 mm or more, such as about 1.5 mm or more, such as about 2 mm or more, such as about 2.5 mm or more, such as about 3 mm or more, such as between about 0.7 mm and about 3 mm, such as between about 1 mm and 2.3 mm, such as about 1.8 mm, such as about 1.3 mm. In addition or alternatively to what is shown, the edge beads may have a non-circular cross-section, such as elliptical, oblong, rectangular or other shapes with convex or other features.

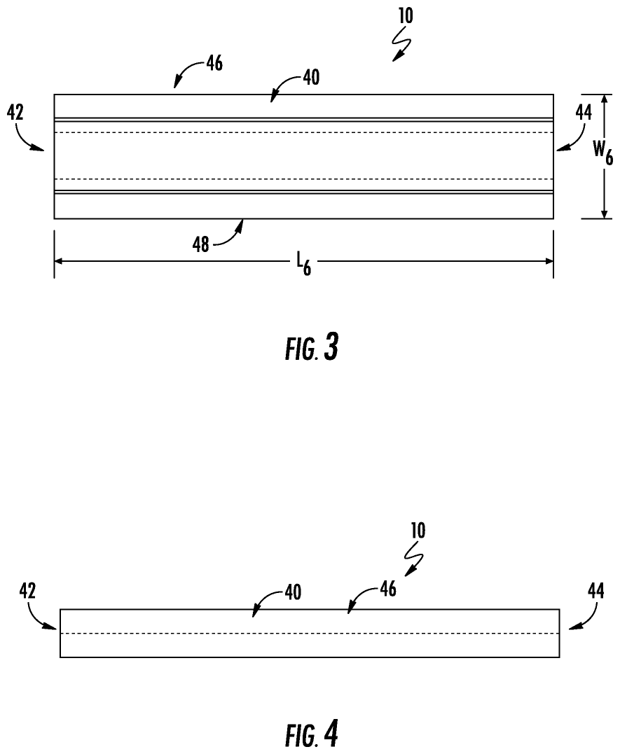

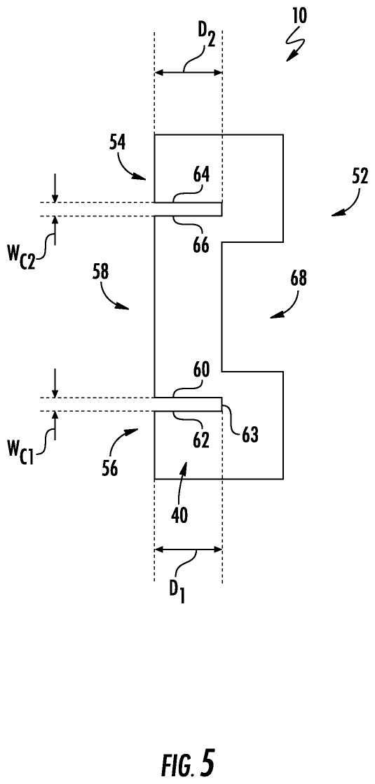

Referring to FIGS. 3-5, the sheet edge strip separation device 10 is illustrated in isolation. Referring first to FIGS. 3 and 4, the sheet edge strip separation device 10 includes a separation body 40 having opposite ends 42 and 44 and sides 46 and 48 that extend between the ends 42 and 44 forming a rectangular shape, however, other shapes may be used. The separation body 40 has a width W_{b} and a length L_{b} that is greater than the width W_{b}, such as about 2 times greater or more, such as about 3 times greater or more, such as about 4 times greater or more. The length L_{b} may be selected based on the length L of the glass sheet 16. In some embodiments, the length L_{b} may be less than the length L, such as about 0.75 L or less, such as about 0.5 L or less, such as between about 0.4 L and about 0.75 L, such as between about 0.4 L and about 0.5 L.

Referring now to FIG. 5, the separation body 40 of the sheet edge strip separation device 10 includes a first face 50 and an opposite second face 52. The separation body 40 has a first edge receiving channel 54 and a second edge receiving channel 56 that is spaced from the first edge receiving channel 54. In the illustrated embodiment, the first edge receiving channel 54 extends in a lengthwise direction of the sheet edge strip separation device 10 parallel to the second edge receiving channel 56, however, other non-parallel arrangements are possible. For example, the edge receiving channels may intersect.

The first and second edge receiving channels 54, 56 are of fixed dimension and formed integrally as part of the separation body 40. The first edge receiving channel 54 has a width W_{c1} and the second edge receiving channel has a width W_{c2}. The widths W_{c1} and W_{c2}, in the illustrated embodiment, are different in order to accommodate glass sheet edge portions of different thicknesses. As an example, the widths W_{c1} and W_{c2} may be between about 0.5 mm and about 3 mm, such as about 1.5 mm, such as about 2 mm. In one embodiment, the width W_{c1} is about 2 mm and the width W_{c2} is about 1.5 mm. Referring also to FIG. 1, the widths W_{c1} and W_{c2} may be slightly larger than the thickness T₂ of the quality portion 14 of the glass sheet 16 in order to accommodate the thickness T₁ of one or both of the edge beads 36 and 38. In the example of FIG. 1, the edge portion 24 is received within the second edge receiving channel 56, between a first channel wall 60 and a second channel wall 62. The edge portion 24 may be slid into the second edge receiving channel 56 until the edge bead 36 abuts an end wall 63 of the second edge receiving channel 56. As an example, the thickness T₂ may be about 1.8 mm and the width W_{c2} may be about 2 mm. Thus, the edge bead 36 may have a thickness T₂ of about 0.2 mm or less greater than that of the thickness T₁ in order to be received within the second edge receiving channel 56.

The first channel wall 60 has a depth D₁ and the second channel wall 62 has a depth D₂. In some embodiments, the depths D₁ and D₂ are about the same; however, the depths D₁ and D₂ may be different. The depths D₁ and D₂ may be selected to be about the same as the distances d₁ and d₂ of the first and second edge portions 24 and 34. In other embodiments, the depths D₁ and D₂ are less than the distances d₁ and d₂ of the first and second edge portions 24 and 34. For example, D₁ may be about 0.75d₁ or less, such as about 0.5d₁ or less.

Likewise, the first edge receiving channel 54 includes a first channel wall 64 and a second channel wall 66. The first channel wall 64 has a depth D₁ and the second channel wall 66 has a depth D₂. In some embodiments, the depths D₁ and D₂ of the first and second channel walls 64 and 66 are about the same; however, the depths D₁ and D₂ may be different. The depths D₁ and D₂ of the first and second channel walls 64 and 66 may be selected to be about the same as the distances d₁ and d₂ of the first and second edge portions 24 and 34. In other embodiments, the depths D₁ and D₂ of the first and second channel walls 64 and 66 are less than the distances d₁ and d₂ of the first and second edge portions 24 and 34. For example, D₁ of the first and second channel walls 64 and 66 may be about 0.75d₁ or less, such as about 0.5d₁ or less.

The sheet edge strip separation device 10 may be formed of any suitable material, such as metals (e.g., aluminum, steel, etc.), plastics, rubber, foam, and wood. In the illustrated embodiment, the separation body 40 is formed as a single, monolithic piece of material. Any suitable method may be used to form the sheet edge strip separation device, such as casting, molding and/or machining. The sheet edge strip separation device 10 may also be formed of multiple materials and include other features, such as a coating. The second face 52 may include a notch 68 or other weight-reducing feature, such as a hole bored through the separation body 40.

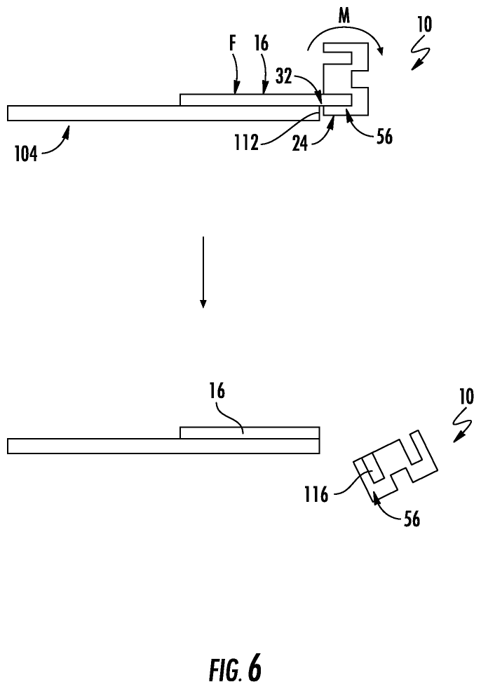

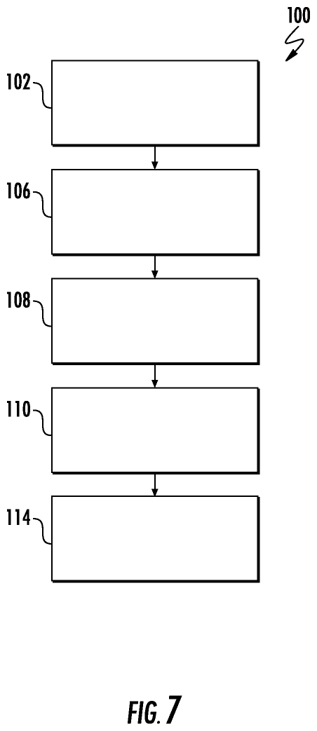

FIG. 6 illustrates the sheet edge strip separation device 10 in use and FIG. 7 illustrates a corresponding method 100 of use. At step 102, the glass sheet 16 is placed on a support surface, such as table 104 such that first edge portion 24 extends beyond an edge 112 of the table 104. A clamping force F is applied to the glass sheet 16 at a location separated from first edge portion 24 using, for example, a hand or clamping device at step 106. At step 108, one of the first and second edge receiving channels 54 and 56 is slid over the first edge portion 24. In some embodiments, it may be desired to orient the sheet edge strip separation device 10 such that the other of the first and edge receiving channels is located above the glass sheet 16 for additional leverage. Which of the first and second glass edge channels 54 and 56 that are used may depend on the thickness of the glass sheet 16. At step 110, a rotating force M is applied to the sheet edge strip separation device 10 which causes a crack to propagate through the thickness of the glass sheet 16 and along the score line 32. At step 114, a glass edge strip 116 is removed from the quality portion 14 of the glass sheet 16. The process may be repeated for the second edge portion 34.

The above-described sheet edge strip separation device 10 may be used with a number of brittle sheet formed materials, such as glass and glass-ceramics. Glass-ceramic articles can be engineered through chemical strengthening, such as through ion exchange, to design or control the properties of the strengthened article. Below is a general description of strengthened glass-ceramic articles that can be processed using the edge strip separation devices described above.

As used herein, the term “glass-ceramic” are solids prepared by controlled crystallization of a precursor glass and have one or more crystalline phases and a residual glass phase.

As used herein, a “vitreous” region or layer refers to a surface region with a lower percentage of crystals than an inner region. The vitreous region or layer can be formed through (i) the decrystallization of one or more crystalline phases of a glass-ceramic article during ion exchange, (ii) the lamination or fusing of a glass to a glass-ceramic, or (iii) other means known in the art such as formation while ceramming a precursor glass into a glass-ceramic.

As used herein, “depth of compression” or “DOC” refers to the depth of a compressive stress (CS) layer and is the depth at which the stress within a glass-ceramic article changes from compressive stress to tensile stress and has a stress value of zero. According to the convention normally used in the art, compressive stress is expressed as a negative (<0) stress and tensile stress is expressed as a positive (>0) stress. Throughout this description, however, and unless otherwise noted, CS is expressed as a positive or absolute value—that is, as recited herein, CS=|CS|.

As disclosed herein, when glass-ceramic articles are subjected to certain ion exchange conditions one or more of the crystalline phases can be “decrystallized” to form a surface region or layer that has a lower area percentage of crystals than an inner region of the glass-ceramic article. In this decrystallization process one or more of the crystalline phases can be broken down by the ion exchange process. This surface region with the lower area percentage of crystals can have different properties than the inner region of the glass-ceramic article, such as differences in reduced modulus and/or hardness, which in turn can lead to the surface of the glass-ceramic article having better scratch performance than a glass-ceramic article that is ion exchanged without this surface region with a lower area percentage of crystals. The creation of this surface region can also lead to unique stress profile characteristics wherein both the surface region and a portion of the inner region are under compressive stress and the depth of the compression layer goes into the inner region. In other embodiments, these same properties can be created in a laminate where in a glass article is laminated to a glass-ceramic article.

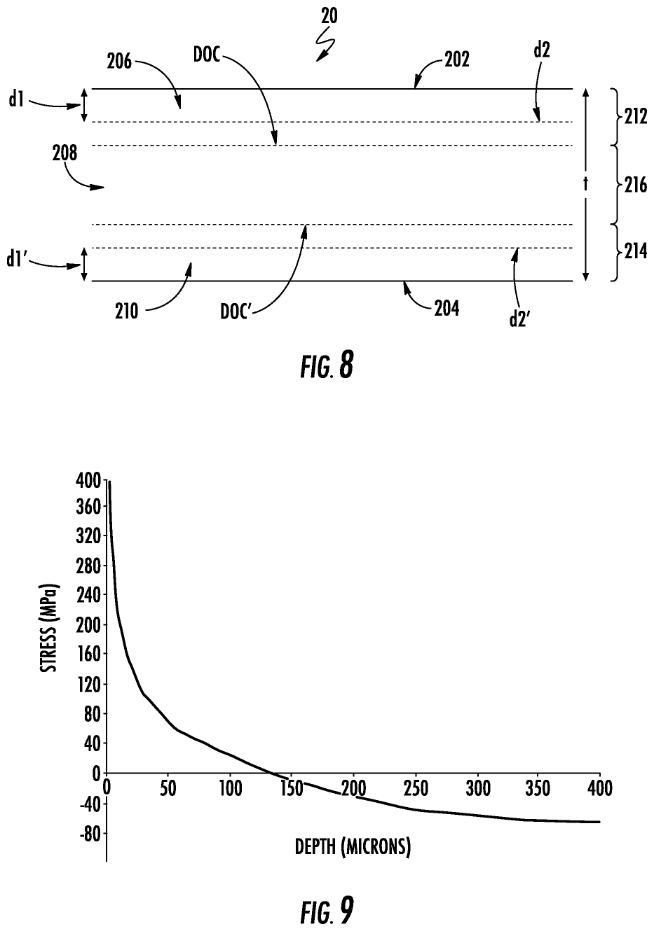

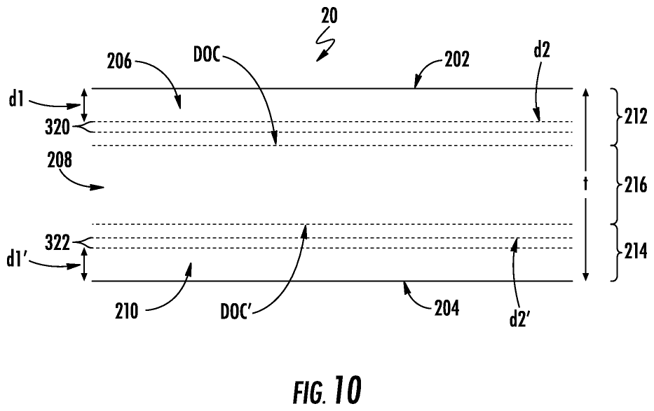

FIG. 8 depicts an exemplary cross-sectional side view of a strengthened glass-ceramic article 200 in the form of a glass sheet having a first surface 202 and an opposing second surface 204 separated by a thickness (t). In some embodiments, strengthened glass-ceramic article 200 has been ion exchanged and has a vitreous outer region 206 (or first region) extending from first surface 202 to a first depth d1. An inner region 208 (or second region) extends from a second depth d2 greater than or equal to first depth d1. In some embodiments, strengthened glass-ceramic article 200 also has a vitreous outer region 210 (or third region) extending from second surface 204 to a third depth d1′. In embodiments where strengthened glass-ceramic article 200 has vitreous outer regions 206 and 210, inner region 208 extends from second depth d2 to a fourth depth d2′, wherein fourth depth d2′ is measured from second surface 204 and is greater than or equal to third depth d1′. First depth d1 of vitreous outer region 206 and third depth d1′ of vitreous outer region 210 can be equal or different. Similarly second depth d2 and fourth depth d2′ can be equal or different. In some embodiments, the strengthened glass-ceramic article has only a single vitreous outer region 206, and in such instances, inner region 208 extends from second depth d2 to second surface 204. FIG. 8 illustrates an embodiment wherein d1 equals d2 and d1′ equals d2′, but this is merely exemplary. In other embodiments, as discussed below with respect to FIG. 10, d2 is greater than d1 and/or d2′ is greater than d1′.

In some embodiments, vitreous outer regions 206 and/or 210 may have a lower area percentage of crystals than inner region 208 of the glass-ceramic article 200 as determined by SEM imaging as discussed above. For example the vitreous outer regions may have an area percentage of crystals in a range from 0% to 15%, and any ranges or subranges therebetween. In some embodiments, the vitreous outer regions may have an area percentage of crystals of less than or equal to 15%, 10%, or 5%.

Strengthened glass-ceramic article 200 also has a compressive stress (CS) layer 212 extending from first surface 202 to a depth of compression (DOC). In some embodiments, as shown in FIG. 8, the DOC is greater than first depth d1 of vitreous outer region 206 such that vitreous outer region 206 and a portion of inner region 208 is under compressive stress and that the DOC is located in inner region 208. In other embodiments, DOC may be less than or equal to first depth d1 of vitreous outer region 206. In some embodiments, as shown in FIG. 8, the glass-ceramic article 200 also has a compressive stress (CS) layer 214 extending from second surface 204 to a depth of compression DOC′. There is also a central tension region 216 under tensile stress in between DOC and DOC′. In some embodiments, as shown in FIG. 8, the DOC′ is greater than third depth d1′ of vitreous outer region 210 such that vitreous outer region 210 and a portion of inner region 208 is under compressive stress and that the DOC′ is located in inner region 208. In other embodiments, DOC′ may be less than or equal to third depth d1′ of vitreous outer region 210.

FIG. 9 illustrates an exemplary stress profile for the first half of the thickness (0.5*t) for glass-ceramic article 200. The x-axis represents the stress value (with positive stress being compressive stress and negative stress being tensile stress and the y-axis represents the depth within the glass-ceramic article as measured from first surface 202. As can be seen in FIG. 9, in some embodiments the stress profile can have a buried CS (maximum CS) below first and/or second surfaces 202, 204 and the stress profile from buried peak to buried peak can be described as quasi-parabolic.

In some embodiments, as shown in FIG. 9, the maximum CS can be below first surface 202 and/or second surface 204. While in other embodiments, the maximum CS may be at first surface and/or second surface 204. In some embodiments, the maximum CS and/or average CS in first CS layer 212 may be different than the maximum CS and/or average CS in second CS layer 214. In other embodiments, the maximum CS can be located below first surface 202 and/or second surface 204. In some embodiments, the maximum CS for first CS layer 212 and/or second CS layer 214 may be located 0.1 to 25 microns and any ranges or subranges therebetween from respective first and second surfaces 202, 204. In some embodiments, the maximum CS for first CS layer 212 and/or second CS layer 214 may be in respective vitreous outer region 206/210 In some embodiments, the average CS in vitreous outer regions 206, 210 can be in a range from 50 MPa to 1500 MPa and any ranges and subranges therebetween,

As noted above, DOC and/or DOC′ may be present in inner region 208 (stated another way, first and/or second CS layers 212, 214 may extend into inner region 208). In such embodiments, inner region 208 may have a maximum compressive stress greater than or equal to 10 MPa, 20 MPa or 30 MPa at least 5 microns into the inner region. In some embodiments, first and/or second CS layers 212, 214 may extend past vitreous region regions 206, 210 and into inner region 208 in a range from greater than 0*t to 0.3*t, and all ranges and subranges therebetween wherein t is the thickness of the glass ceramic article 200.

In some embodiments, the maximum CT is in a range from 10 MPa to 170/√t, wherein t is the thickness of the glass-ceramic article in millimeters. In some embodiments, the maximum CT is greater than or equal to 10 MPa, 20 MPa, 30 MPa, 40 MPa, 50 MPa, 60 MPa, 70 MPa, 80 MPa, 90 MPa, 100 MPa, 110 MPa, 120 MPa, 130 MPa, 140 MPa, or 150 MPa. In some embodiments, the maximum CT can be in a range from 10 MPa to 150 MPa, or any range and subranges therebetween.

In some embodiments, the depth of a compressive stress layer, for example DOC and/or DOC′ is greater than the depth of the vitreous outer regions d1, d1′. In some embodiments, the depth of a compressive stress layer, for example DOC and/or DOC′ is in a range from 0.05*t to 0.3*t, and all ranges and subranges therebetween wherein t is the thickness of the glass ceramic article. In other embodiments, the depth of a compressive stress layer is in a range from 0.05 mm to 0.6 mm, and all ranges and subranges therebetween.

In some embodiments, a vitreous outer region (for example 206, 210) may have a thickness in a range from about 100 nm to 25 μm, and all ranges and subranges therebetween.

In some embodiments, vitreous outer region(s) may transition into the inner region. For example, vitreous outer region(s) may be characterized as having (i) a substantially uniform area percentage of crystals and/or substantially uniform lithium ion concentration and/or (ii) a gradient of increasing crystals and/or lithium ion concentration with increase in depth from the surface with a first average slope The transition region may be characterized as having a gradient of area percentage of crystals and/or lithium ion concentration, wherein the area percentage of crystals and/or lithium ion concentration increases from the vitreous outer region(s) to the inner region with a second average slope having a larger absolute value than the absolute value of the first average slope of the vitreous outer region(s). The inner region may be characterized as having (i) at least a portion with a substantially uniform area percentage of crystals and/or lithium ion concentration and/or (ii) a portion with a gradient of increasing crystals and/or lithium ion concentration with increase in depth from the surface with a third average slope, wherein the absolute value of the second average slope of the transition region is larger than the absolute value of the average third slope of the inner region. In some embodiments, the absolute value of the average second slope of the transition region is at least 3 times the absolute value of the average first slope of the vitreous region(s) and/or the absolute value of the average third slope of the inner region. In some embodiments, a transition region may be formed when the vitreous outer regions are formed through the decrystallization of one or more crystalline phases of a glass-ceramic article during ion exchange. In some embodiments, the transition region may have a depth in a range from greater than 0 μm to 40 μm, and all ranges and subranges therebetween.

FIG. 10 is an exemplary illustration of strengthened glass-ceramic article 200 with a transition region 320 between vitreous outer region 206 and inner region 208 and a transition region 322 between vitreous outer region 210 and inner region 208. As shown in FIG. 10, in some embodiments where there are transition regions 320 and 322, the inner region is defined by the thickness between d2 and d2′, d2 is greater than d1 and d2′ is greater than d1′, transition region 320 is defined by the thickness between d1 and d2, and transition region 322 is defined by the thickness between d1′ and d2′. FIG. 10 is merely exemplary, and as noted above it is possible that there is only a single vitreous outer region and there is a transition region between the single vitreous outer region and the inner region. In other embodiments, there may be first and second vitreous outer regions as shown in FIG. 10, but there is only a single transition region (either 320 or 322). In some embodiments, for example when the vitreous outer layer is formed through the lamination or fusing of a glass to a glass-ceramic, the transition between the vitreous outer region(s) and the inner region is a transition point rather than a transition region.

In some embodiments, the reduced modulus of the vitreous outer region(s) is less than reduced modulus of the inner region. In some embodiments, the reduced modulus of the vitreous outer region(s) is in a range from 5% to 30%, and any ranges and subranges therebetween less than the reduced modulus of the inner region. It is believed that the lower reduced modulus for the vitreous outer region(s) improves the scratch performance of the glass-ceramic article. Reduced modulus is related to Young's modulus and the reduced modulus can be converted into Young's modulus based on the following relationship: 1/Eᵣ=[(1−v²)/E]+[(1−vᵢ²)/Eᵢ] wherein Eᵣ is the reduced modulus, E is the Young's modulus, v is Poisson's ratio, Eᵢ is the Young's modulus of the nanoindenter, and vᵢ is Poisson's ratio of the nanoindenter.

In some embodiments, the hardness of the vitreous outer region(s) is less than hardness of the inner region. In some embodiments, the hardness of the vitreous outer region(s) is in a range from 5% to 30%, and any ranges and subranges therebetween less than the hardness of the inner region. It is believed that the lower hardness for the vitreous outer region(s) improves the scratch performance of the glass-ceramic article, as shown in more detail in Example 2 below. Hardness is measured according to the nanoindentation procedure described above

In some embodiments, the glass-ceramic article is transparent in that it has an average transmittance of 85% or greater, 86% or greater, 87% or greater, 88% or greater, 89% or greater, 90% or greater, 91% or greater, 92% or greater, 93% or greater (including surface reflection losses) of light over the wavelength range from 450 nm to 600 nm for a glass-ceramic article having a thickness of 1 mm. In other embodiments, glass-ceramic may be translucent over the wavelength range from 450 nm to 600 nm. In some embodiments a translucent glass-ceramic can have an average transmittance in a range from about 20% to less than about 85% of light over the wavelength range of about 450 nm to about 600 nm for a glass-ceramic article having a thickness of 1 mm. In some embodiments, vitreous outer regions 206, 210 have a lower refractive index than inner region 208.

In some embodiments, the glass-ceramic article has a thickness t in a range from 0.2 mm to 4 mm, 0.2 mm to 3 mm, 0.2 mm to 2 mm, 0.2 mm to 1.5 mm, 0.2 mm to 1 mm, 0.2 mm to 0.9 mm, 0.2 mm to 0.8 mm, 0.2 mm to 0.7 mm, 0.2 mm to 0.6 mm, 0.2 mm to 0.5 mm, 0.3 mm to 4 mm, 0.3 mm to 3 mm, 0.3 mm to 2 mm, 0.3 mm to 1.5 mm, 0.3 mm to 1 mm, 0.3 mm to 0.9 mm, 0.3 mm to 0.8 mm, 0.3 mm to 0.7 mm, 0.3 mm to 0.6 mm, 0.3 mm to 0.5 mm, 0.4 mm to 4 mm, 0.4 mm to 3 mm, 0.4 mm to 2 mm, 0.4 mm to 1.5 mm, 0.4 mm to 1 mm, 0.4 mm to 0.9 mm, 0.4 mm to 0.8 mm, 0.4 mm to 0.7 mm, 0.4 mm to 0.6 mm, 0.5 mm to 4 mm, 0.5 mm to 3 mm, 0.5 mm to 2 mm, 0.5 mm to 1.5 mm, 0.5 mm to 1 mm, 0.5 mm to 0.9 mm, 0.5 mm to 0.8 mm, 0.5 mm to 0.7 mm, 0.8 mm to 4 mm, 0.8 mm to 3 mm, 0.8 mm to 2 mm, 0.8 mm to 1.5 mm, 0.8 mm to 1 mm, 1 mm to 2 mm, 1 mm to 1.5 mm, and all ranges and subranges therebetween. In some embodiments, the glass-ceramic article may be substantially planar and flat. In other embodiments, the glass-ceramic article may be shaped, for example it may have a 2.5D or 3D shape. In some embodiments, the glass-ceramic article may have a uniform thickness and in other embodiments, the glass-ceramic article may not have a uniform thickness.

In some embodiments, the glass-ceramic articles disclosed herein may be a laminate. In such embodiments, vitreous region(s) may be a glass layer and the inner region may be a glass-ceramic. The glass may be any suitable glass that is ion-exchangeable, for example a glass containing alkali metal ions. In such embodiments, the vitreous region(s) have a zero (0) area percentage of crystals. The glass and glass-ceramic layers may be laminated together through conventional means. In some embodiments, lamination can include fusing the layers together. In other embodiments, lamination excludes layers that are fused together. In some embodiments, the layers may be ion-exchanged first and then laminated. In other embodiments, the ion exchange may occur after lamination.

The above-described sheet edge strip separation devices allow for increased pressure to be applied to the relatively narrow glass edge portion, while rotating the sheet edge strip separation device manually to separate a glass edge strip from a quality portion of the glass sheet. The sheet edge strip separation devices allow for thicker and thinner, e.g., up to about 2 mm in thickness so that glass sheets with thickness variability can be separated as well as a variety of glass thicknesses. The sheet edge strip separation devices are not limited to specific glass compositions, but can be utilized on glass and glass-ceramics with a Vickers hardness, for example, in the range 600 to 800. The weight of the edge portion and force applied by the sheet edge strip separation device supply the force needed to vent and separate the glass edge strip, without skin contact with the edge portion of the glass sheet. The length of the sheet edge strip separation devices can be selected to reduce glass chipping and cantilever chip defects thereby improving glass separation yields. Glass chip size can also be reduced below 100 μm by providing equal pressure across a wider area of the glass sheet.

It should be emphasized that the above-described embodiments of the present invention, particularly any “preferred” embodiments, are merely possible examples of implementations, merely set forth for a clear understanding of various principles of the invention. Many variations and modifications may be made to the above-described embodiments of the invention without departing substantially from the spirit and various principles of the invention. All such modifications and variations are intended to be included herein within the scope of this disclosure and the following claims. For example, the features may be combined according to the following embodiments of the disclosure.

Embodiment 1. A method of separating an edge strip of a sheet of brittle material using a handheld sheet edge strip separation device, the method comprising:

sliding an edge receiving channel of a separation body of the sheet edge strip separation device over an edge portion that includes an edge of the sheet of brittle material, the edge receiving channel having a fixed width and is integrally formed as part of the separation body;

rotating the sheet edge strip separation device to provide a force over an area of the edge portion; and

separating the edge strip from a quality portion of the sheet of brittle material with the edge strip located in the edge receiving channel.

Embodiment 2. The method of Embodiment 1, further comprising forming a score line along a length of the sheet of brittle material, wherein the edge strip is separated along the score line.

Embodiment 3. The method of Embodiment 2, wherein the edge portion extends an entire length of the sheet of brittle material and the separation body has a length that is less than the entire length of the sheet of brittle material.

Embodiment 4. The method of any one of Embodiments 1-3 further comprising supporting the sheet of brittle material on a table, the edge portion extending off the table.

Embodiment 5. The method of any one of Embodiments 1-4, wherein the separation body has a first end, a second opposite end and the edge receiving channel intersecting both the first end and the second, opposite end.

Embodiment 6. The method of any one of Embodiments 1-5, wherein the edge receiving channel is a first edge receiving channel, the separation body comprising a second edge receiving channel, the second edge receiving channel having a fixed width and is integrally formed as part of the separation body.

Embodiment 7. The method of any one of Embodiments 1-6, wherein the separation body is formed as a single monolithic piece of material.

Embodiment 8. The method of any one of Embodiments 1-7, wherein the sheet of brittle material comprises a strengthened glass or glass-ceramic.

Embodiment 9. A handheld sheet edge strip separation device, comprising:

a separation body comprising an edge receiving channel that extends along a length of the separation body, the edge receiving channel having a fixed width and is integrally formed as part of the separation body;

wherein the edge receiving channel is sized to receive an edge portion of a sheet of brittle material.

Embodiment 10. The sheet edge strip separation device of Embodiment 9, wherein the separation body is formed as a single monolithic piece of material.

Embodiment 11. The sheet edge strip separation device of Embodiment 9 or Embodiment 10, wherein the separation body has a first end, a second opposite end and the edge receiving channel intersecting both the first end and the second, opposite end.

Embodiment 12. The sheet edge strip separation device of any one of Embodiments 9-11, wherein the edge receiving channel is a first edge receiving channel, the separation body comprising a second edge receiving channel, the second edge receiving channel having a fixed width and is integrally formed as part of the separation body.

Embodiment 13. The sheet edge strip separation device of Embodiment 12, wherein the first and second edge receiving channels are parallel.

Embodiment 14. The sheet edge strip separation device of any one of Embodiments 9-13, wherein the edge receiving channel has the fixed width of no more than about 3 mm.

Embodiment 15. The sheet edge strip separation device of any one of Embodiments 9-14, wherein the edge receiving channel has the fixed width of between about 1.5 mm and about 2 mm.

Embodiment 16. The sheet edge strip separation device of any one of Embodiments 9-15, wherein the separation body has a length that is at least about 2 times a width of the separation body, the edge receiving channel extending along the length of the separation body.

Embodiment 17. A method of forming a handheld sheet edge strip separation device, the method comprising:

forming a separation body of the sheet edge strip separation device, the separation body having a first end, a second end and sides that extend from the first end to the second end; and

providing the separation body with an edge receiving channel that extends inwardly from a face of the separation body, the edge receiving channel having a fixed width and is integrally formed as part of the separation body.

Embodiment 18. The method of Embodiment 17, wherein the edge receiving channel intersects the first and second ends.

Embodiment 19. The method of Embodiment 17 or Embodiment 18, wherein the edge receiving channel is a first edge receiving channel, the separation body comprising a second edge receiving channel, the second edge receiving channel having a fixed width and is integrally formed as part of the separation body.

Embodiment 20. The method of Embodiment 19, wherein the first and second edge receiving channels are parallel.

1. A method of separating an edge strip of a sheet of brittle material using a handheld sheet edge strip separation device, the method comprising:
sliding an edge receiving channel of a separation body of the sheet edge strip separation device over an edge portion that includes an edge of the sheet of brittle material, the edge receiving channel having a fixed width and is integrally formed as part of the separation body;
rotating the sheet edge strip separation device to provide a force over an area of the edge portion; and
separating the edge strip from a quality portion of the sheet of brittle material with the edge strip located in the edge receiving channel.

2. The method of claim 1, further comprising forming a score line along a length of the sheet of brittle material, wherein the edge strip is separated along the score line.

3. The method of claim 2, wherein the edge portion extends an entire length of the sheet of brittle material and the separation body has a length that is less than the entire length of the sheet of brittle material.

4. The method of claim 1, further comprising supporting the sheet of brittle material on a table, the edge portion extending off the table.

5. The method of claim 1, wherein the separation body has a first end, a second opposite end and the edge receiving channel intersecting both the first end and the second, opposite end.

6. The method of claim 1, wherein the edge receiving channel is a first edge receiving channel, the separation body comprising a second edge receiving channel, the second edge receiving channel having a fixed width and is integrally formed as part of the separation body.

7. The method of claim 1, wherein the separation body is formed as a single monolithic piece of material.

8. The method of claim 1, wherein the sheet of brittle material comprises a strengthened glass or glass-ceramic.

9. A handheld sheet edge strip separation device, comprising:
a separation body comprising an edge receiving channel that extends along a length of the separation body, the edge receiving channel having a fixed width and is integrally formed as part of the separation body;
wherein the edge receiving channel is sized to receive an edge portion of a sheet of brittle material.

10. The sheet edge strip separation device of claim 9, wherein the separation body is formed as a single monolithic piece of material.

11. The sheet edge strip separation device of claim 9, wherein the separation body has a first end, a second opposite end and the edge receiving channel intersecting both the first end and the second, opposite end.

12. The sheet edge strip separation device of claim 9, wherein the edge receiving channel is a first edge receiving channel, the separation body comprising a second edge receiving channel, the second edge receiving channel having a fixed width and is integrally formed as part of the separation body.

13. The sheet edge strip separation device of claim 12, wherein the first and second edge receiving channels are parallel.

14. The sheet edge strip separation device of claim 9, wherein the edge receiving channel has the fixed width of no more than about 3 mm.

15. The sheet edge strip separation device of claim 9, wherein the edge receiving channel has the fixed width of between about 1.5 mm and about 2 mm.

16. The sheet edge strip separation device of claim 9, wherein the separation body has a length that is at least about 2 times a width of the separation body, the edge receiving channel extending along the length of the separation body.

17. A method of forming a handheld sheet edge strip separation device, the method comprising:
forming a separation body of the sheet edge strip separation device, the separation body having a first end, a second end and sides that extend from the first end to the second end; and
providing the separation body with an edge receiving channel that extends inwardly from a face of the separation body, the edge receiving channel having a fixed width and is integrally formed as part of the separation body.

18. The method of claim 17, wherein the edge receiving channel intersects the first and second ends.

19. The method of claim 17, wherein the edge receiving channel is a first edge receiving channel, the separation body comprising a second edge receiving channel, the second edge receiving channel having a fixed width and is integrally formed as part of the separation body.

20. The method of claim 19, wherein the first and second edge receiving channels are parallel.
